(19) United States
(12) Patent Application Publication
(10) Pub. No.: US 2006/0201341 A1
(43) Pub. Date: Sep. 14, 2006

(54) Flip ramp mechanical interlock for appliance

(76) Inventor: Colin Michael Kernan, Stamford, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/433,270

(22) Filed: May 12, 2006

Related U.S. Application Data
(63) Continuation of application No. 11/045,426, filed on Jan. 28, 2005, now Pat. No. 7,069,839.
Application No. 11/045,426 is a continuation of application No. 10/878,245, filed on Jun. 28, 2004, now Pat. No. 6,907,819.

(51) Int. Cl. B23Q 15/00

(52) U.S. Cl. 99/492

(57) ABSTRACT

A locking system for an appliance has lid and feed chute locking components that include a spring-biased, ramp surfaced pivoting arm that is adapted to be activated to extend or retract a rod that activates or de-activates a motor drive of a food processor. The arm is activated by rotational movement of the lid relative to the bowl, as an extension member attached to the lid, which is activated by insertion of the plunger, extends downwardly from the lid and engages the ramp surface of the pivoting arm when the lid is rotated. Thus, the plunger can remain inside of the food chute of the lid while the lid is removed or replaced.

### CROSS-REFERENCE TO RELATED APPLICATIONS

This application is a continuation application and claims priority to provisional application No. 60/483,934 filed Jul. 1, 2003, U.S. application Ser. No. 10/878,245 filed Jun. 28, 2004 and U.S. application Ser. No. 11/045,426 filed Jan. 28, 2005, the entire disclosures of which are hereby incorporated by reference.

### BACKGROUND OF THE INVENTION

1. Field of the Invention

The present invention relates to appliances such as food appliances and, more particularly, to appliances in which a mechanical lock is used to prevent activation of a motor or drive until a physical condition is satisfied such as when a cover is securely fastened on a food processor.

2. Description of Related Art

It is known in the art to provide mechanical activations means in various forms that activate a drive or motor when a device is in a condition such as a locked position for safety or proper function. Such devices are in a disabled mode when the condition is not met, such as when a lock or cover is not in place.

Specifically with respect to food processors, such as the one schematically shown in FIGS. 1-2. As shown in the exploded diagram of FIG. 1, a food processor base (10) has contained therein a motor and drive means (not shown) to engage and drive a blade shaft and blade (not shown) within a cylindrically shaped bowl (12) for chopping or mixing food. The motor or drive is rendered operable, or activated, only when a switch (14) is activated. A first rod (16) is located within a hollow channel (18) adjacent to a handle (20) outside of the bowl (12). The first rod (16) is biased by a spring (22) that engages a first flange (24) fixed to the rod (16). A second flange (26) is located at the top of the rod (16). Referring to FIG. 2, the first rod (16) is moved against the spring (22) by a downward force directed from a second rod (30) that is fixed to a plunger (28), when the plunger (28) is pushed into a food chute (32) which is integrally formed with a round lid (34) that covers the bowl (12). A channel (36) is provided for the second rod (30) to pass through. When the first rod (16) is moved as shown in FIG. 2, its lower end engages the switch (14) to activate the motor or drive in the base (10).

A problem associated with a design such as that described in FIGS. 1-2, is that when the second rod (30) is engaged as shown in FIG. 2, it is not possible to remove the lid (34) from the bowl (12), since the lid (34) locks relative to the bowl (12) by a relative rotational motion about axis Z in order to engage ramp wedges or bayonet lock features (not shown) commonly used on food processor lids. Thus, attempting to unlock the lid (34) from the bowl (12) by relative rotation would be prevented because the second rod (30) extends between the two and acts like a deadbolt or sliding lock. When it is desired to remove the lid (34) to access the inside of the bowl (12), therefore, it is necessary to first remove the plunger (28) from the food chute (32) to that the second rod (30) no longer impedes the rotational movement of the lid (34) relative to the bowl (12). This is cumbersome and may create a mess in the working space since food particles may be attached to the plunger (28). This problem is associated with known food processors of the type having a wide mouth feed chute, since these are designed to be disabled when the plunger is not inside the feed chute as a safety measure.

It is desirable, therefore, to provide a superior mechanical system for enabling and disabling a motor or drive in a food processor of the type having a wide mouth feed chute that facilitates removal of a lid from a bowl without the need to first remove the plunger.

These and other objects are achieved by the present invention described herein.

### BRIEF SUMMARY OF THE INVENTION

The present invention locking system for an appliance is directed to lid and feed chute locking components that include a spring-biased, ramp surfaced pivoting arm that is adapted to be activated to extend or retract a rod that activates or de-activates a motor drive of a food processor. The arm is activated by rotational movement of the lid relative to the bowl, as an extension member attached to the lid, which is activated by insertion of the plunger, extends downwardly from the lid and engages the ramp surface of the pivoting arm when the lid is rotated. Thus, the plunger can remain inside of the food chute of the lid while the lid is removed or replaced.

### BRIEF DESCRIPTION OF THE DRAWINGS

FIGS. 1-2 are diagrammatic illustrations in the exploded side, and side view, respectively, of a prior art appliance.

FIG. 3 is a diagrammatic side view of an appliance in accordance with a preferred embodiment of the present invention.

FIGS. 4A-4B are partial, diagrammatic front views of the present invention.

FIG. 5 is a partial, diagrammatic side view of the present invention.

FIG. 6 is a partial, diagrammatic perspective view of the present invention.

FIG. 7 is a side view of a component of the present invention.

FIG. 8 is a perspective view of a component of the present invention.

FIG. 9 is a front view of a component of the present invention.

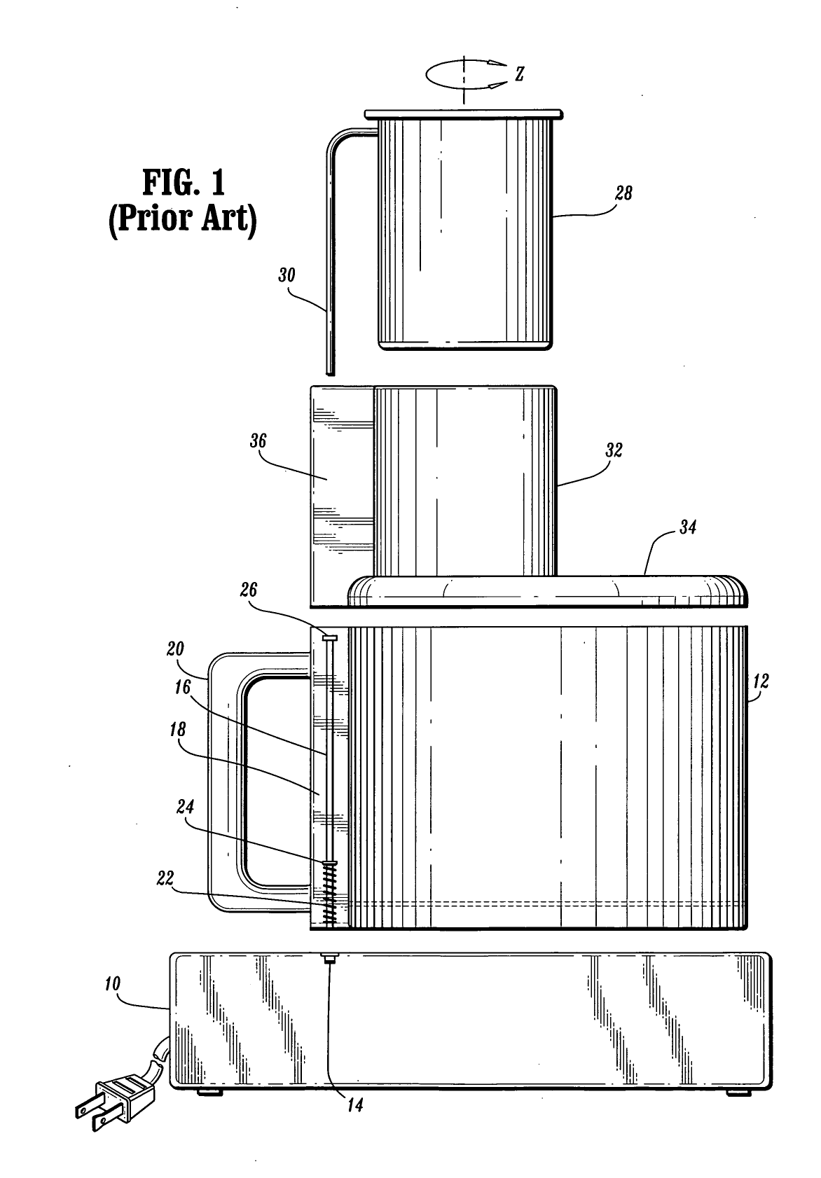

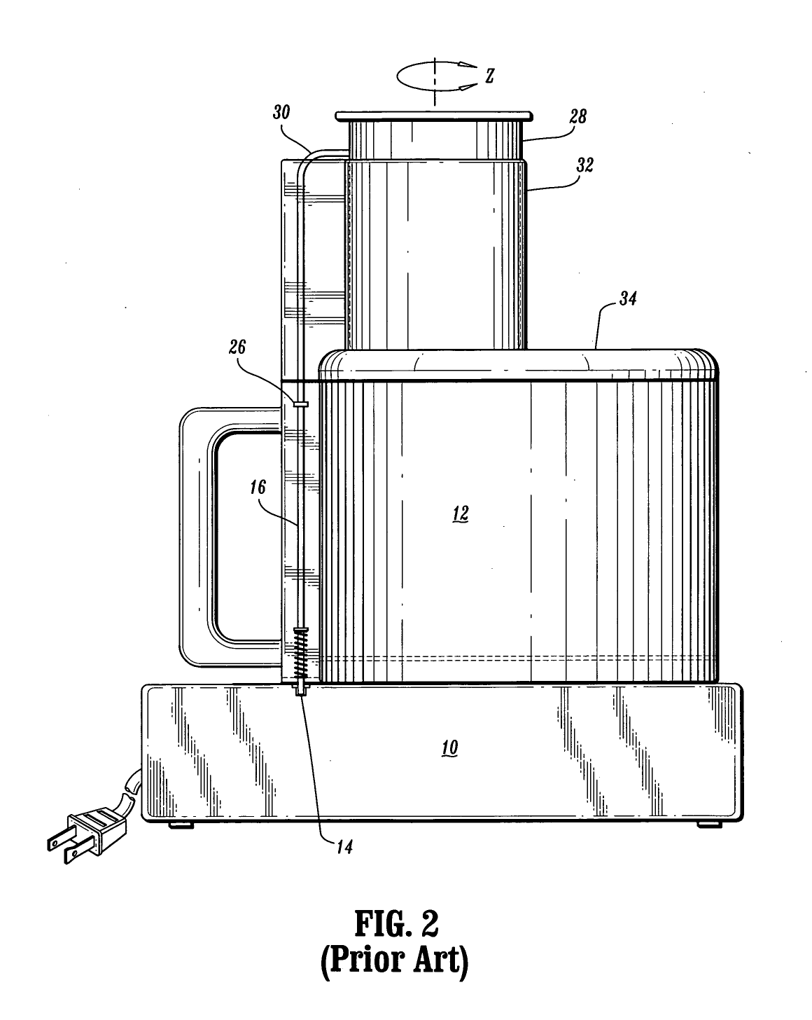

### DESCRIPTION OF THE PREFERRED EMBODIMENT

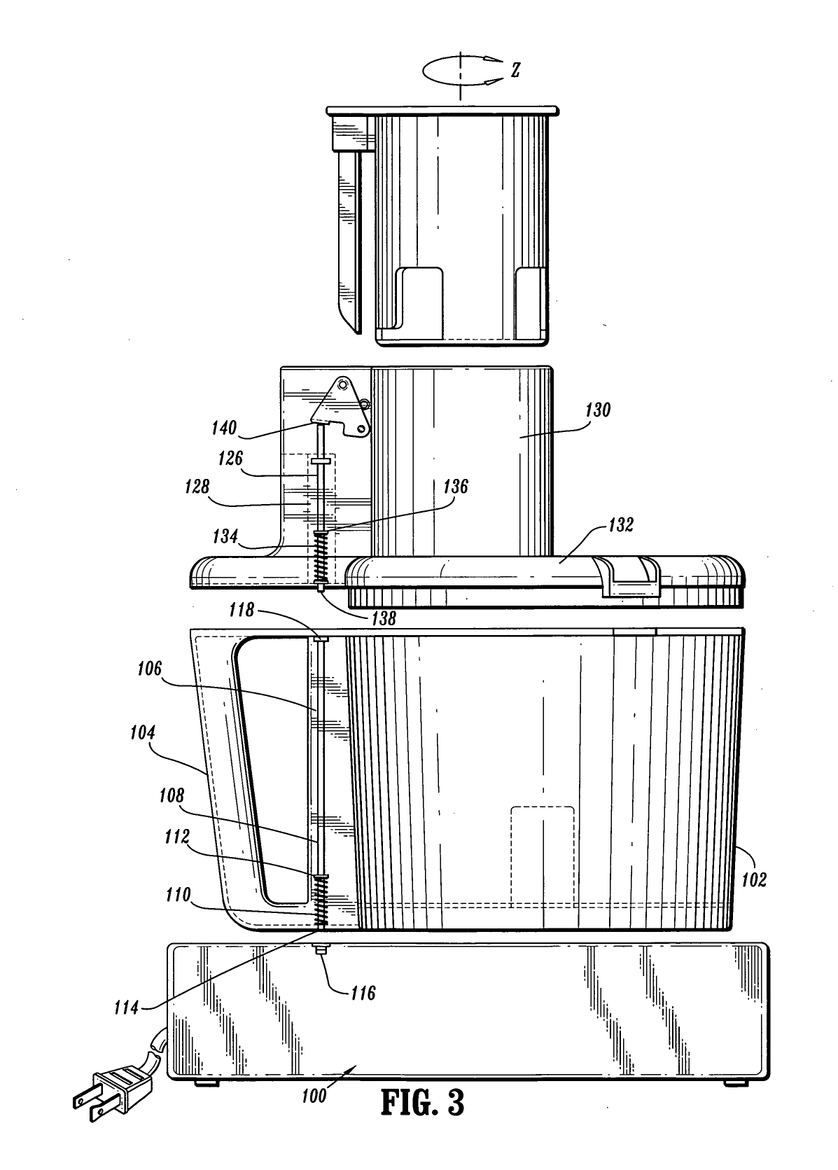

A schematic side view of the present invention is shown in FIG. 3. A base (100) houses an electric motor and drive assembly of the type generally known (not shown) for driving a food processor blade (not shown) housed in the cylindrically shaped bowl (102). The bowl (102) comprises a handle (104) and a vertical channel (106). Located in the vertical channel (106) is a linearly movable rod (108) that is mounted for vertical movement within the channel (106). The rod (108) is supported on a compression spring (110) that cooperates with a flange (112) on the rod (108). The tip (114) of the rod (108) extends through an opening in the channel (106) so that it may extend below the bowl (102) when the spring (110) is compressed. When the spring (110) is fully compressed, the rod tip (114) engages a switch (116) of the type generally known that enables or activates the electric motor and/or drive for the food processor blade. When the spring (110) is relaxed, the rod tip (114) is disengaged from the switch (116).

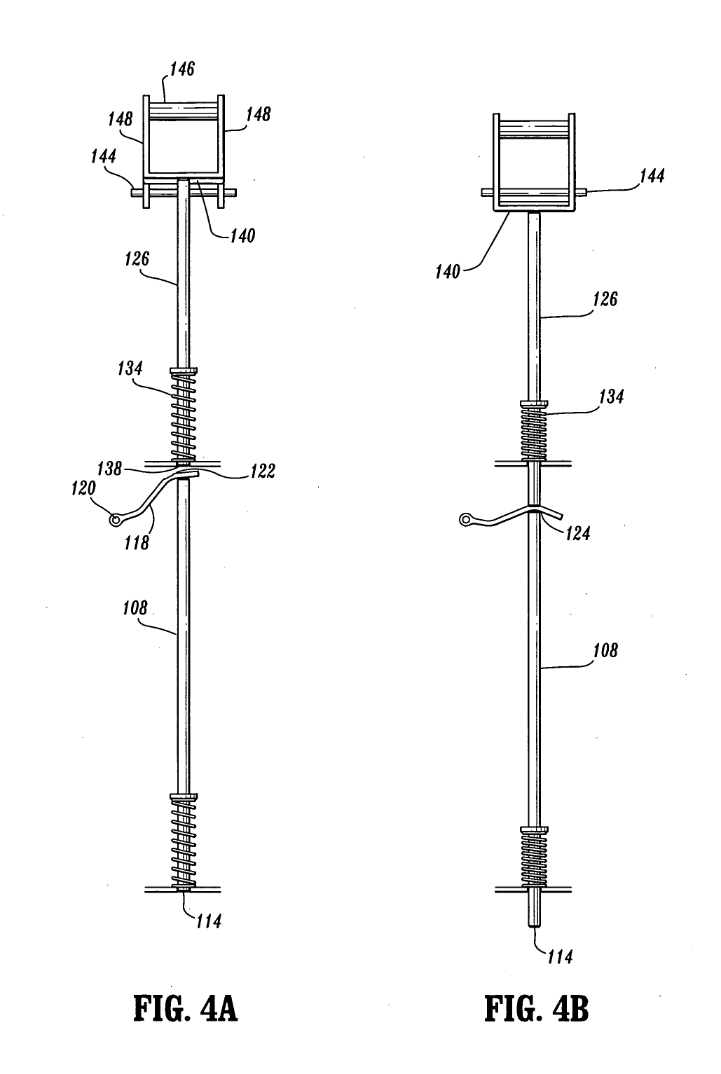

Referring to FIGS. 3, 4A and 4B, where FIGS. 4A and 4B are partial, schematic front views of the present invention, a pivoting arm (118) hinged at a pin (120) and having an upper contact surface (122) and a lower contact surface (124) is positioned above the first rod (108) so that the lower contact surface (124) is in contact with the top of the first rod (108). A second rod (126) is mounted in a vertical channel (128) formed adjacent to a food chute (130) that is integral with the lid (132). The second rod (126) is mounted for vertical movement within the channel (128) and is supported by a compression spring (134) that engages a flange (136) on the rod (126). As shown in FIG. 4A, when the second rod (126) is resting and the compression spring (134) is relaxed, the tip (138) of the second rod (126) is positioned above the arm (118). As shown in FIG. 4B, when the compression spring (134) is compressed, the tip (138) extends downwardly. This causes the tip (138) to contact the switch (116) and activate the motor and/or drive of the chopping blade.

The second rod (126) is moved downwardly by a force applied by a contact member (140) of a pivoting mechanism (142) that comprises a hinge (144), a roller (146) supported by a pair of upper arms (148) connected to the hinge (144), and the contact member (140) which comprises two arm parts and a contact area that contacts the rod (126).

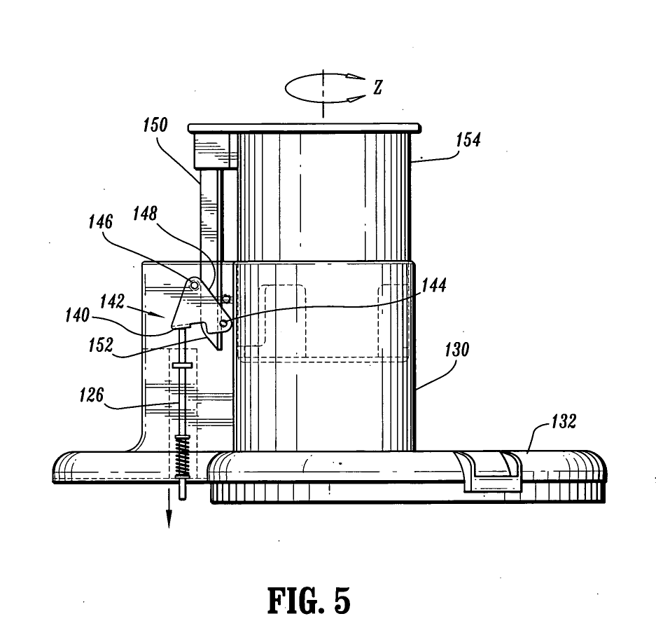

The pivoting mechanism (142) is caused to pivot between the positions shown in FIGS. 4A-4B by force applied through an elongated beveled member (150) having an upper end attached to the plunger (154) and a lower end (152) that is beveled. In a condition where the lid (132) is secured in place, and the first rod (108) and the second rod (126) are vertically aligned, the plunger (154) is pushed into the food chute (130), the lower end (152) bevel engages the roller (146) and causes the pivoting mechanism (142) to pivot from the position of FIG. 4A to the position of FIG. 4B as a result of the roller (146) riding up the beveled section and onto the maximum width of the beveled member (150) as shown in FIG. 5.

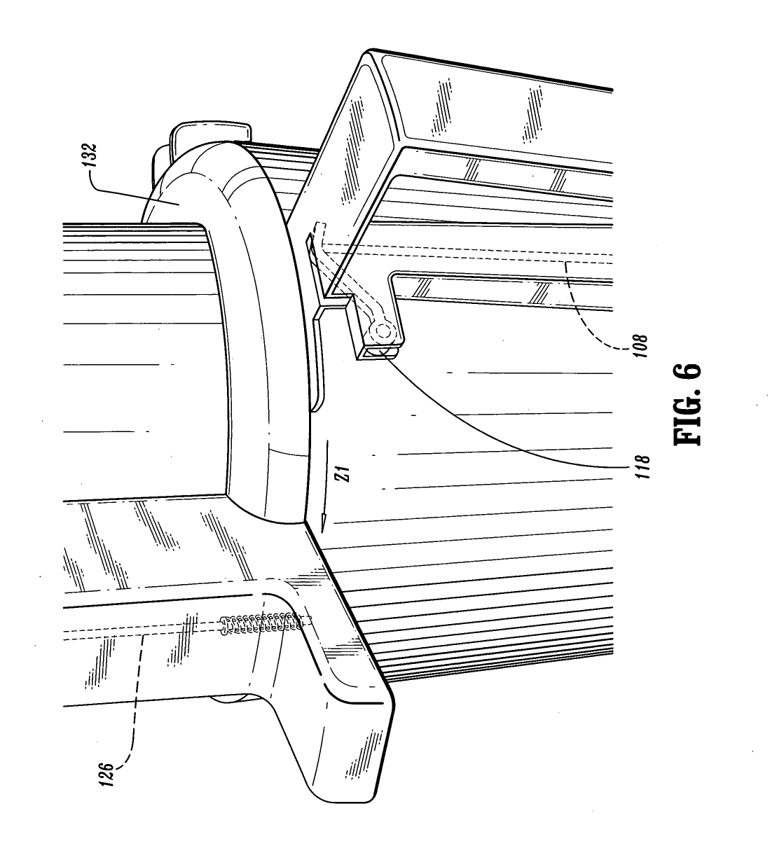

In order to remove the lid (132) without first removing the plunger (154), the lid (132) is rotated relative to the bowl (102) in the direction Z1 as shown in FIG. 6. This movement causes the second rod (126) to move in from the condition of FIG. 4B to the condition of FIG. 6, thereby releasing the pivoting arm (118) so that it is free to pivot up as shown in FIG. 6 and in FIG. 4A under the force of the spring (110). This action disables the switch (116) be allowing the first rod (108) to move upward under the bias of the spring (110). In order to re-attach the lid (132) and re-activate the switch (116), the rotational movement of the lid (132) is reversed, opposite of Z1, so that the second rod (126) will ride against the pivoting arm (118) to cause the condition shown in FIG. 4B.

If desired, the plunger (154) may be removed from the chute (130) causing the first and second rods to release the switch under spring pressure.

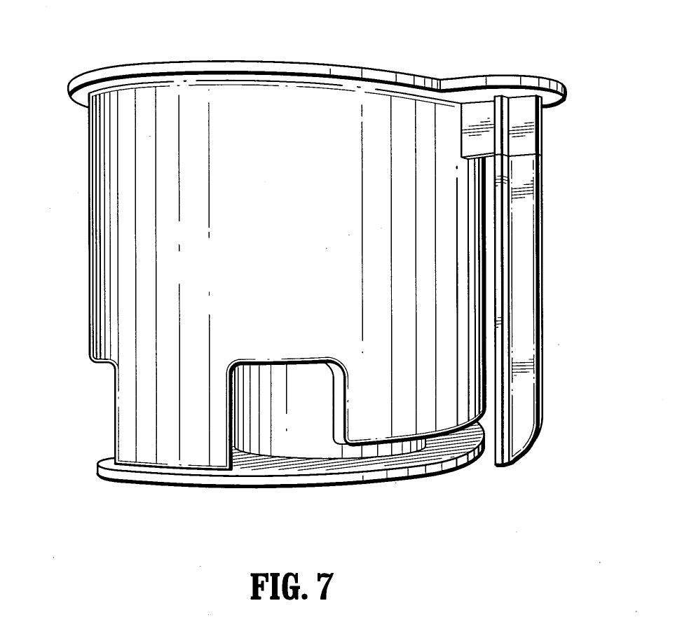

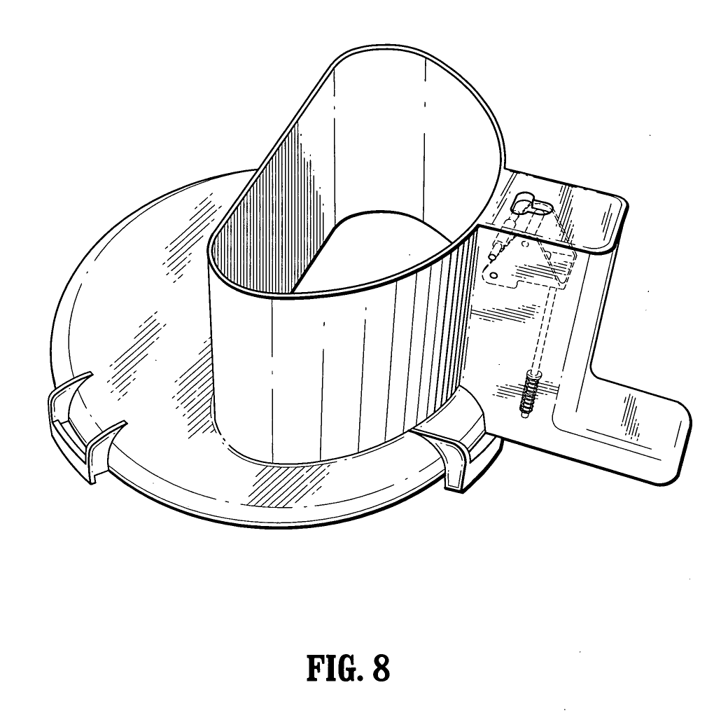

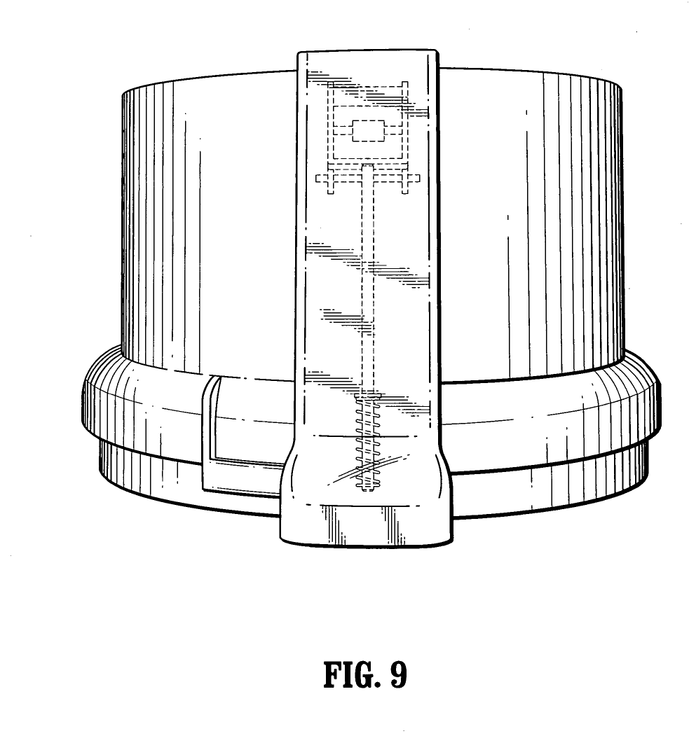

FIG. 7 is an illustration of the plunger (154) and beveled member (150). FIGS. 8-9 are illustrations of the lid and chute (130), the second rod (126), and the pivoting mechanism (142).

It is understood that the present invention has applicability to other appliances and is not limited to food processors. While a preferred embodiment of the invention has been herein disclosed and described, it is understood that various modifications can be made without departing from the scope of the invention.

What is claimed is:

1. A food appliance comprising
a base housing a motor and a drive shaft;
a bowl adapted to mount on said base, said bowl having an opening therethrough allowing said drive shaft to be received in said bowl;
a food processing implement adapted to be attached to and driven by said drive shaft while positioned in said bowl;
a lid selectively attachable to and detachable from said bowl;
a feed tube extending from said lid and adapted to receive food product therethrough for guiding said food product into said bowl;
a plunger adapted to be selectively positioned into said feed tube and advanced therein, or to be selectively removed from said feed tube;
a pivoting transmission member pivotally attached to said feed tube; and
a switching assembly adapted to enable activation of said motor when said lid is in a predetermined position on said bowl and when said plunger is received at least partially into said feed tube such that said plunger causes said pivoting transmission member to pivot from a first position to a second position thereby causing a first extending member movably attached to at least one of said lid and said feed tube to extend therefrom and to contact an actuation member movably attached to at least one of said bowl and said handle, said actuation member thereby activating said motor; and
wherein said first member is removed from contact with said actuation member to disable activation of said motor either when said plunger is removed at least partially from said feed tube or when said lid is moved away from said predetermined position.

2. An appliance according to claim 1, wherein
at least one of said transmission member and said actuation member has at least one ramp surface to facilitate contact between said transmission member and said actuation member when said lid is moved into said predetermined position.

3. An appliance according to claim 1, wherein
said actuation member is spring-biased between first and second positions.

4. An appliance according to claim 1, wherein
said actuation member is spring-biased in first position in which said motor activation is disabled, and is moved by said first member to a second position in which said motor is activated.

5. An appliance according to claim 4, wherein
said actuation member is in said first position when said lid is not in said predetermined position, and said actuation member is in said second position when said lid is in said predetermined position.

6. An appliance according to claim 4, wherein
said actuation member is in said first position when said lid is not in said predetermined position or when said lid is in said predetermined position and said plunger is not fully received in said feed tube, and said actuation member is in said second position when said lid is in said predetermined position.

7. An appliance according to claim 4, wherein
said actuation member is in said first position when said lid is not in said predetermined position or when said lid is in said predetermined position and said plunger is not fully received in said feed tube, and said actuation member is in said second position when said lid is in said predetermined position and said plunger is at least partially received in said feed tube.

8. A food appliance comprising
a base housing a motor and a drive shaft;
a bowl adapted to mount on said base, said bowl having an opening therethrough allowing said drive shaft to be received in said bowl;
a food processing implement adapted to be attached to and driven by said drive shaft while positioned in said bowl;
a lid selectively attachable to and detachable from said bowl;
a feed tube extending from said lid and adapted to receive food product therethrough for guiding said food product into said bowl;
a plunger adapted to be selectively positioned into said feed tube and advanced therein, or to be selectively removed from said feed tube;
a transmission member movably attached to at least one of said feed tube and said lid;
a switching assembly adapted to enable activation of said motor when said lid is in a predetermined position on said bowl and when said plunger is received at least partially into said feed tube such that said plunger causes said transmission member to move from a first position to a second position thereby causing a first extending member movably attached to at least one of said lid and said feed tube to extend therefrom and to contact an actuation member movably attached to said bowl, said actuation member thereby activating said motor; and
wherein said first member is removed from contact with said actuation member to disable activation of said motor either when said plunger is removed at least partially from said feed tube or when said lid is moved away from said predetermined position.

9. An appliance according to claim 8, wherein
at least one of said transmission member and said actuation member has at least one ramp surface to facilitate contact between said transmission member and said actuation member when said lid is moved into said predetermined position.

10. A food appliance comprising
a base housing a motor and a drive shaft;
a bowl adapted to mount on said base, said bowl having an opening therethrough allowing said drive shaft to be received in said bowl;
a food processing implement adapted to be attached to and driven by said drive shaft while positioned in said bowl;
a lid selectively attachable to and detachable from said bowl;
a feed tube extending from said lid and adapted to receive food product therethrough for guiding said food product into said bowl;
a plunger adapted to be selectively positioned into said feed tube and advanced therein, or to be selectively removed from said feed tube;
a pivoting transmission member pivotally attached to said feed tube; and
a switching assembly adapted to enable activation of said motor when said lid is in a predetermined position on said bowl and when said plunger is received at least partially into said feed tube such that said plunger causes said pivoting transmission member to pivot from a first position to a second position, and
wherein said switching assembly further comprises an arm adapted to enable a user to selectively disable activation of said motor either when said plunger is removed at least partially from said feed tube or when said lid is moved away from said predetermined position regardless of the position of said plunger.

11. A food appliance according to claim 10, wherein
said switching assembly comprises a transmission assembly for transmitting force generated by movement of said plunger to a switch, whereby said force is applied to said switch to enable activation of said motor.

12. A food appliance according to claim 11, wherein
said transmission assembly comprises a first transmission member attached to said plunger and adapted to engage said pivoting transmission member which engages a second transmission member moveably attached to said lid, whereby movement of said plunger relative to said lid causes said first transmission member to impart movement on said pivoting transmission member and said second transmission member, which causes force to be applied to said switch to enable activation of said motor.

13. A food appliance according to claim 12, wherein
said transmission assembly further comprises a third transmission member moveably attached to said bowl, whereby movement of said second transmission member imparts movement on said third transmission member, which causes force to be applied to said switch to enable activation of said motor.

14. A food appliance according to claim 13, wherein
said third transmission member comprises a distal end tip adapted to press said switch when said third transmission member is moved in response to movement of said plunger.

15. A food appliance according to claim 12, wherein
said first transmission member comprises at least one elongated rib member.

16. A food appliance according to claim 12, wherein
said second transmission member comprises a spring-biased component that is selectively moveable between a position in which it enables activation of said motor and a position in which it disables activation of said motor.

17. A food appliance according to claim 16, wherein
said transmission assembly further comprises a third transmission member moveably attached to said bowl, whereby movement of said second transmission member imparts movement on said third transmission member, which causes force to be applied to said switch to enable activation of said motor.

18. A food appliance comprising
a base housing a motor and a drive shaft;
a bowl adapted to mount on said base, said bowl having an opening therethrough allowing said drive shaft to be received in said bowl;
a food processing implement adapted to be attached to and driven by said drive shaft while positioned in said bowl;
a lid selectively attachable to and detachable from said bowl;
a feed tube extending from said lid and adapted to receive food product therethrough for guiding said food product into said bowl;
a plunger adapted to be selectively positioned into said feed tube and advanced therein, or to be selectively removed from said feed tube;
a pivoting transmission member pivotally attached to said feed tube; and
a switching assembly adapted to enable activation of said motor when said lid is in a predetermined position on said bowl and when said plunger is received at least partially into said feed tube such that said plunger causes said pivoting transmission member to pivot from a first position to a second position, and
wherein said switching assembly further comprises an engagement member adapted to enable a user to selectively disable activation of said motor either when said plunger is removed at least partially from said feed tube or when said lid is moved away from said predetermined position regardless of the position of said plunger.
